(19) United States
(12) Patent Application Publication
(10) Pub. No.: US 2009/0282424 A1
(43) Pub. Date: Nov. 12, 2009

(54) RECORDING MEDIUM LOADING AND UNLOADING APPARATUS THAT CAN PREVENT LIGHT FROM FALLING ON RECORDING MEDIUM

(76) Inventors: Takuya Kato, Miyagi-ken (JP); Kiyoyuki Ito, Miyagi-ken (JP)

Correspondence Address: BRINKS HOFER GILSON & LIONE, P.O. BOX 10395, CHICAGO, IL, 60610, US

(21) Appl. No.: 12/066,547

(22) PCT Filed: Sep. 7, 2006
(86) PCT No.: PCT/JP2006/317719

§ 371 Date: Mar. 12, 2008

(30) Foreign Application Priority Data
Sep. 12, 2005 (JP) 2005 264023

(51) Int. Cl. G11B 17/04

(52) U.S. Cl. 720/601; G9B/17.013

(57) ABSTRACT

The present invention provides a recording medium loading and unloading apparatus for loading and unloading a recording medium that is housed in a case and forms a cartridge and on which information is optically recorded. This recording medium loading and unloading apparatus 1 includes a housing that has an insertion slot 10 into which the cartridge C is inserted and that forms a closed space shielded from outside light in cooperation with a door 12 that openably closes the insertion slot 10, and a shutter opening mechanism 90 that is provided in the housing and that opens a shutter 83 openably provided in the case of the cartridge C to expose part of the recording medium from the case. The shutter opening mechanism 90 opens the shutter 83 only when the insertion slot 10 is closed by the door 12.

The present application is a continuation of PCT Application No. PCT/JP2006/317719, filed on Sep. 7, 2006, which claims priority to Japanese Patent Application No. 2005-264023, filed on Sep. 12, 2005. Both of these applications are incorporated by reference for all purposes.

### 1. TECHNICAL FIELD

The present invention relates to a recording medium loading and unloading apparatus for loading and unloading a recording medium on which predetermined information is recorded, and more specifically, it relates to a recording medium loading and unloading apparatus for loading and unloading a recording medium from which information is optically read and onto which information is optically written.

### 2. BACKGROUND ART

At present, recording media such as FDs (floppy disks), MDs (minidisks), CDs (compact disks), and DVDs (digital versatile disks) are widely used for recording a large quantity of data. Some of such recording media are housed in a case and form a cartridge. In such a case, part of the recording medium is exposed from the case by opening a shutter openably and closably provided in the case, and information is read from or written onto the recording medium through the exposed portion.

The reading or writing of information from or onto such a cartridge-type recording medium is performed, normally, by introducing the cartridge into an apparatus including a shutter opening mechanism for opening the shutter and an information processing unit for reading or writing information. Specifically, for example, in an apparatus that optically reads and writes information from and onto a recording medium, upon insertion of a cartridge into the apparatus through an insertion slot having an openable and closable door (hereinafter referred to as door), the shutter of the cartridge is opened by the shutter opening mechanism, and part of the recording medium is exposed from the case. After the cartridge in that state is placed on a turntable, the recording medium is rotated by the rotation of the turntable, and an optical pickup that serves as the information processing unit is moved in the radial direction of the recording medium, thereby reading or writing information from or onto the recording medium (see, for example, Patent Document 1).

Patent Document 1: Japanese Unexamined Patent Application Publication No. 6-223473

### DISCLOSURE OF THE INVENTION

### Problems to be Solved by the Invention

In recent years, the desire to record high-definition moving images and the desire to record a larger quantity of data due to the development of personal computers have been increasing. However, in the optical recording media such as CDs and DVDs, the density cannot be sufficiently increased to record such a large quantity of data, and therefore such a large quantity of data cannot be recorded on a single disk. Therefore, a large quantity of data is divided and recorded on a plurality of disks.

With such a background, recently, a hologram recording medium on which a larger quantity of data can be recorded compared to the present CDs and DVDs has been drawing attention. In this hologram information recording, a light beam is split into two coherent light beams. One of the two light beams is data-modulated by a spatial light modulator and is used as a signal light beam. The other light beam is used as a reference light beam. By combining these light beams on a recording medium, data is recorded in the form of an interference fringe. Therefore, in such hologram information recording, it is important not to expose the recording medium to light before information is recorded. If outside light falls on the recording medium before information is recorded, the recording medium reacts to light, the optical characteristics deteriorate, and recording of information can become impossible.

However, in the above-described known apparatus having the shutter opening mechanism, the shutter of the cartridge case is opened by the shutter opening mechanism, with a door of an insertion slot for inserting the cartridge not completely closed. Therefore, outside light can enter the apparatus through the insertion slot, and the light can fall on the exposed portion of the recording medium. Such a situation is a large problem particularly in hologram information recording.

The present invention is made in view of this. An object of the present invention is to provide a recording medium loading and unloading apparatus that can prevent light from falling on a recording medium at times other than during reading and writing of information from and onto the recording medium.

### Means for Solving the Problems

The present invention provides a recording medium loading and unloading apparatus for loading and unloading a recording medium that is housed in a case and forms a cartridge and on which information is optically recorded. The apparatus includes a housing, a loading mechanism, and a shutter opening mechanism. The housing has an insertion slot into which the cartridge is inserted and forms a closed space shielded from outside light, in cooperation with a door that openably closes the insertion slot. The loading mechanism introduces the cartridge inserted through the insertion slot, into the housing. The shutter opening mechanism is provided in the housing and opens a shutter provided in the case of the cartridge to expose part of the recording medium from the case during introduction of the cartridge into the housing by the loading mechanism. The shutter opening mechanism opens the shutter only when the insertion slot is closed by the door.

Since the shutter is opened and part of the recording medium is exposed from the case only when the insertion slot is closed by the door, that is, the housing is completely shielded from light, light can be prevented from falling on the recording medium at times other than during reading and writing of information from and onto the recording medium.

It is preferable that the recording medium loading and unloading apparatus of the present invention further include a door opening mechanism that opens the door in conjunction with the loading mechanism.

In the recording medium loading and unloading apparatus of the present invention, it is preferable that the door opening mechanism include a rotating member that has a door engaging portion engageable with the door and that is rotated in conjunction with the loading mechanism and thereby opens the door using the door engaging portion, and a door-opening-timing control unit that is provided in the loading mechanism and that engages with the rotating member and rotates this at a predetermined time and thereby controls the timing of opening of the door by the rotating member.

In the recording medium loading and unloading apparatus of the present invention, it is preferable that the door-opening-timing control unit be a cam groove that rotates the rotating member to position the door engaging portion at a position engageable with the door when the cartridge is introduced into the housing by the loading mechanism and that rotates the rotating member at a predetermined time to open the door using the door engaging portion when the cartridge is removed from the housing by the loading mechanism.

In the recording medium loading and unloading apparatus of the present invention, it is preferable that the shutter opening mechanism include a shutter opening member that has a shutter engaging portion engaging with the shutter and that is rotated in conjunction with the loading mechanism and thereby opens the shutter using the shutter engaging portion, and a cam groove that engages with the shutter opening member and that defines the timing of opening of the shutter by the shutter opening member so that the shutter opening member is rotated with the door closed.

In the recording medium loading and unloading apparatus of the present invention, it is preferable that the loading mechanism include a slider that moves along the insertion direction of the cartridge, and a carrier that is linked to the slider via a link mechanism and that has a placing surface for placing the cartridge. The carrier is moved, with the movement of the slider, between an unloading position at which the cartridge is transferred through the insertion slot and a loading position at which the cartridge is positioned in the housing.

It is preferable that the recording medium loading and unloading apparatus of the present invention further include a driving unit that generates torque for moving the slider, and a force converting mechanism that converts the torque generated in the driving unit into force in a straight direction and transmits the force to the slider.

### ADVANTAGES

Since the shutter is opened and part of the recording medium is exposed from the case only when the insertion slot is closed by the door, that is, the housing is completely shielded from light, light can be prevented from falling on the recording medium at times other than during reading and writing of information from and onto the recording medium.

### BEST MODE FOR CARRYING OUT THE INVENTION

The embodiment of the present invention will now be described in detail with reference to the drawings.

The recording medium loading and unloading apparatus 1 according to this embodiment is an apparatus for supplying a hologram recording medium to an optical region where information is written onto the hologram recording medium or information is read from the hologram recording medium. As shown, for example, in FIG. 1, the recording medium loading and unloading apparatus 1 includes a cartridge carrier 2, a sled 4, and a frame member 6. The cartridge carrier 2 transports a cartridge C that includes a case and a hologram recording medium housed in the case, between a predetermined loading position and unloading position. The sled 4 movably supports the cartridge carrier 2 and moves the cartridge carrier 2 between the loading position and the optical region. The frame member 6 forms part of a housing that supports the cartridge carrier 2 and the sled 4. The housing forms a closed space in cooperation with a below-described door 12 that openably closes an insertion slot 10. The closed space houses the cartridge carrier 2, the sled 4, and the optical region, which are shielded from outside light.

The hologram recording medium housed in the case of the cartridge C is shielded from light. When a shutter 83 (see, for example, FIG. 1) openably and closably provided in the case is opened, part of the hologram recording medium is exposed from the case, so that a predetermined optical processing for reading or writing information can be performed. For the sake of convenience, the direction in which the cartridge carrier 2 moves between the loading position and the unloading position will hereinafter be referred to as loading direction. The side near the loading position in the loading direction will be defined as back, and the side near the unloading position in the loading direction will be defined as front.

The recording medium loading and unloading apparatus 1 has the insertion slot 10 for inserting the cartridge C into the apparatus. The insertion slot 10 is formed in the front end face 6a of the frame member 6 and is elongated rectangular in shape. The insertion slot 10 is opened and closed by the door 12 (see, for example, FIG. 8). The door 12 is openably and closably supported by a door guide 13 (see, for example, FIG. 8) provided in the frame member 6.

The recording medium loading and unloading apparatus 1 has a loading mechanism for moving the cartridge carrier 2 in the loading direction and introducing the cartridge C placed on the cartridge carrier 2 into the apparatus 1. The loading mechanism includes a slider 17, a driving mechanism 20 (see FIG. 7), and a link mechanism 22. The slider 17 drives in the loading direction. The driving mechanism 20 drives the slider 17. The link mechanism 22 links the slider 17 and the cartridge carrier 2 and transmits driving force of the slider to the cartridge carrier 2.

As shown, for example, in FIGS. 4 to 7, the slider 17 is a plate-like member that has side surfaces 17a and 17b movably engaging with the left and right side walls 6a and 6b (see FIG. 6) of the frame member 6 and a bottom surface 17c and that has a substantially U-shaped cross section. The slider 17 is moved by the driving mechanism 20 in the loading direction. At the rear end of each of the side surfaces 17a and 17b of the slider 17, a substantially L-shaped hook member 24 is supported using a fulcrum pin 25 so as to be able to swing up and down. The hook member 24 has an engaging pin 27 that protrudes sideways, toward the frame member 6. As shown in FIG. 6, the engaging pin 27 movably engages with a guide slit 29 formed in each of the left and right side walls 6a and 6b of the frame member 6. The guide slit 29 includes a straight slit portion 29a that has a predetermined length and that extends straight in the loading direction, and a catching slit portion 29b that is short and that extends downward from the rear end of the straight slit portion 29a.

As shown in FIG. 7, the driving mechanism 20 that drives the slider 17 has a driving source (driving unit) 20A that generates torque, and a force converting mechanism 20B that converts the torque of the driving source 20A into force in a straight direction. The driving source 20A includes a motor 51, a worm gear 52, and first to third slider gears 53, 54, and 55. The motor 51 is fixed to a base plate 300 of the housing. The worm gear 52 is coupled to the rotating shaft of the motor 51. The first to third slider gears 53, 54, and 55 engage with the worm gear 52. The force converting mechanism 20B includes a pin 58 and an elongate hole 59. The pin 58 is fixed to the periphery of the third slider gear 55. The elongate hole 59 is formed in the bottom surface 17c of the slider 17 and engages with the pin 58. The elongate hole 59 extends in the lateral direction (a direction perpendicular to the loading direction), and has a length substantially corresponding to the diameter of the third slider gear 55. In such a structure, when the third slider gear 55 is rotated by the drive of the motor 51, the pin 58 moves the slider 17 in the loading direction, while moving along the elongate hole 59.

As clearly shown in FIGS. 4 to 6, the link mechanism 22 includes a pair of cam carriers 30 and 32 that is disengageably engaged with each hook member 24 and form a first link, and a link member 34 that links the cam carriers 30 and 32 and serves as a second link. In this case, the first cam carrier 30 located on the insertion slot 10 side is disengageably engaged with the hook member 24 using an engaging protrusion 31 integral with the first cam carrier 30. The cam carriers 30 and 32 are rotatably supported using fulcrum pins 35 by carrier guides 4a and 4b that form the left and right side walls of the sled 4. A substantially S-shaped through cam groove 37 is formed in each of the cam carriers 30 and 32. A pair of engaging pins 40 of the cartridge carrier 2 are engaged with these cam grooves 37. In this case, the engaging pins 40 extending from the cartridge carrier 2 are engaged with the cam grooves 37 through guide slits 42 formed in the carrier guides 4a and 4b. Each guide slit 42 includes a straight slit portion 42a that has a predetermined length and that extends straight in the loading direction, and a catching slit portion 42b that is short and that extends downward from the rear end of the straight slit portion 42a.

As clearly shown in FIGS. 8 to 12, the recording medium loading and unloading apparatus 1 of this embodiment has a door opening mechanism 49 for opening the door 12 in conjunction with the operation of the cartridge carrier 2. The door opening mechanism 49 includes door arms 62 that are rotatably supported using fulcrum pins 60 by the left and right side walls 6a and 6b (see FIG. 6) of the frame member 6 and that serve as rotating members. At the upper end of each door arm 62 is provided an opening pin (door engaging portion) 65 that engages with the door 12 and opens the door 12 when the cartridge C is unloaded. The opening pin 65 passes through a guide slit 70 of the door guide 13 that is provided in the frame member 6 and that openably and closably supports the door 12, and faces, for example, an engaging protrusion 72 of the door 12 in the loading direction. The guide slit 70 extends so as to describe an arc of a circle centered at the fulcrum pin 60. The door 12 is urged at all times by an urging spring 75 in the direction closing the insertion slot 10.

At the lower end of each door arm 62 is provided an engaging pin 63. The engaging pin 63 is engaged with a control slit 65 that is formed in each of the side surfaces 17a and 17b of the slider 17 to control the opening timing of the door 12 and that serves as a door-opening-timing control unit. The control slit 65 is formed as a cam groove and includes a first slit portion 65a that is located in the front and that extends in the loading direction, a second slit portion 65b that is located in the rear and that extends in the loading direction, and a transition portion 65c that connects the rear end of the first slit portion 65a and the front end of the second slit portion 65b and that extends vertically. The transition portion 65c forms (below-described) first and second working faces 80 and 81 that function as origins for switching the position of the opening pin 65 relative to the engaging protrusion 72 of the door 12 between both sides of the engaging protrusion 72 in cooperation with the end faces of the slit portions 65a and 65b.

The recording medium loading and unloading apparatus 1 of this embodiment has a shutter opening mechanism 90 for opening the shutter 83 of the cartridge C. The shutter 83 of the cartridge C is urged at all times by the urging force of a spring (not shown) in the closing direction (so as to shield the recording medium from light). The shutter opening mechanism 90 opens the shutter 83 against the urging force of the spring.

The shutter opening mechanism 90 of this embodiment opens the shutter 83 after the cartridge C is introduced into the apparatus 1 and the door 12 is closed. Specifically, as shown in FIGS. 1 to 3, the shutter opening mechanism 90 has a shutter opening member 92 that is attached, for example, to the back of a placing surface 2a of the cartridge carrier 2 on which the cartridge C is placed. The shutter opening member 92 is rotatably supported by the cartridge carrier 2 using a fulcrum pin 99. The shutter opening member 92 has an engaging pin 95 and an engaging protrusion (shutter engaging portion) 96. The engaging pin 95 engages with a guide groove 97 that is formed in the sled 4 and that serves as a cam groove. The engaging protrusion 96 disengageably engages with a depression 83a that is formed on an edge of the shutter 83 of the cartridge C placed on the placing surface 2a of the cartridge carrier 2. In this case, the guide groove 97 includes a straight portion 97a and a rotation guide portion 97b. The straight portion 97a extends in the loading direction. The rotation guide portion 97b has a predetermined length, extends from the rear end of the straight portion 97a in a direction substantially perpendicular to the straight portion 97a, and guides the rotation of the shutter opening member 92. Between the straight portion 97a and the rotation guide portion 97b is formed a working face 100 for defining the opening timing of the shutter 83 (that is, the timing to open the shutter 83 after the cartridge C is introduced into the apparatus 1 and the door 12 is closed). The engaging protrusion 96 is moved, with the rotation of the shutter opening member 92, along a guide groove 102 formed in the placing surface 2a of the cartridge carrier 2.

An opening 105 is formed in the placing surface 2a of the cartridge carrier 2. The opening 105 makes a turntable 107 face the cartridge C placed on the placing surface 2a of the cartridge carrier 2, in an exposed state. The turntable 107 is located at the loading position of the cartridge carrier 2 and is attached and fixed to the sled 4. The turntable 107 holds, for example, magnetically and rotates the hologram recording medium in the cartridge C. The torque rotating the turntable 107 is obtained from a motor 110 attached to the underside of the sled 4.

The recording medium loading and unloading apparatus 1 of this embodiment has a moving mechanism 120 that moves the sled 4 supporting the cartridge carrier 2 relative to the optical region where information is written onto the hologram recording medium or information is read from the hologram recording medium. As clearly shown in FIGS. 13 and 14, the moving mechanism 120 has a lead screw 122, a nut assembly 124, and a guide shaft 130. The lead screw 122 extends straight toward the optical region (in the loading direction in this embodiment) and is rotatable. The nut assembly 124 is fixed to the bottom surface of the sled 4 and is screwed on the lead screw 122. The guide shaft 130 is provided in the base plate 300 of the housing. The guide shaft 130 engages with the sled 4 and guides the movement of the sled 4. The guide shaft 130 passes through the sled 4 and extends parallel to the lead screw 122. The guide shaft 130 guides the translational movement of the sled 4, while restricting the rotation of the sled 4 accompanying the rotation of the lead screw 122. A driving mechanism 200 for rotating the lead screw 122 includes a motor 140, a worm gear 141, and a gear 152. The motor 140 is fixed to the base plate 300. The worm gear 141 is coupled to the rotating shaft of the motor 140. The gear 152 is engaged with the worm gear 141 and is coupled to the lead screw 122.

As shown in FIG. 15 in detail, the nut assembly 124 includes two nuts 160 and 162 and a block 165. The nuts 160 and 162 engage with the lead screw 122. The block 165 forms a closed space that houses the nuts 160 and 162. The nut assembly 124 has a rattle preventing mechanism that prevents rattle due to the backlash between the nuts 160 and 162 and the lead screw 122 in both directions (directions in which the nut assembly 124 moves back and forth). Specifically, the rattle preventing mechanism includes a spring 169 that presses the screwing surfaces (engaging surfaces; threads) of a female screw formed in each of the nuts 160 and 162 and a male screw formed in the lead screw 122 against each other. Specifically, the spring 169 is disposed between the two nuts 160 and 162 and urges the nuts 160 and 162 away from each other. As a results, the spring 169 presses the nuts 160 and 162 against the inner surfaces of the block 165.

Next, the operation of the recording medium loading and unloading apparatus 1 configured as above will be described.

First, insertion of the cartridge C into the apparatus 1 through the insertion slot 10 when the door 12 is closed as shown in FIG. 8 will be described. When the door 12 is closed as shown in FIG. 8, the engaging pins 63 of the door arms 62 are located at the rear ends of the second slit portions 65b of the control slits 65, and the opening pins 65 of the door arms 62 are located at the rear ends of the guide slits 70 and behind the engaging protrusions 72 of the door 12. At this time, the engaging protrusions 72 of the door 12 are located so as to cross the transfer pathways of the opening pins 65 along the guide slits 70.

When the door is closed as shown in FIG. 8, the front end of the cartridge C (the end at which the shutter 83 is located) is pressed against the door 12 of the insertion slot 10, and the cartridge C is inserted into the apparatus 1. As shown in FIG. 9, the door 12 is opened against the urging force of the urging spring 75, the engaging protrusions 72 of the door 12 are retracted from the transfer pathways of the opening pins 65 along the guide slits 70, and the cartridge C is placed on the placing surface 2a of the cartridge carrier 2. In this state, the cartridge C is further inserted into the apparatus 1, that is, into the cartridge carrier 2. The depression 83a of the shutter 83 provided at the front end of the cartridge C engages with the engaging protrusion 96 of the shutter opening member 92 provided on the back of the cartridge carrier 2. The state is shown in FIG. 1. When this state is detected by a sensor (not shown), the motor 51 is driven and the gears 52, 53, 54, and 55 are rotated. Therefore, the pin 58 of the third slider gear 55 that engages with the elongate hole 59 of the slider 17 also rotates, while moving along the elongate hole 59, and moves the slider 17 toward the loading position of the cartridge carrier 2.

In this way, the slider 17 is moved toward the loading position. As shown in FIG. 10, the second working faces 81 of the control slits 65 come into contact with the engaging pins 63 of the door arms 62, with the second slit portions 65b of the control slits 65 engaged with the engaging pins 63 of the door arms 62. The door arms 62 thereby rotate around the fulcrum pins 60 counterclockwise in the figure. Therefore, as shown in FIG. 1, the opening pins 65 of the door arms 62 move along the guide slits 70, and are moved in front of the engaging protrusions 72 of the door 12 that are retracted from the transfer pathways of the opening pins 65. With the movement of the slider 17 to the loading position, the first slit portions 65a of the control slits 65 engage with the engaging pins 63.

In this embodiment, the shape and size of each component is set so that the door 12 can be maintained in the open state (the state in which the engaging protrusions 72 are retracted from the transfer pathways of the opening pins 65 along the guide slits 70) by the cartridge C being inserted until the opening pins 65 move in front of the engaging protrusions 72, and the door 12 can be released from the open state maintained by the cartridge C when the opening pins 65 have moved in front of the engaging protrusions 72. Therefore, when the opening pins 65 have moved in front of the engaging protrusions 72, as shown in FIG. 1, the door 12 is urged by the urging force of the urging spring 75 in the closing direction, and the engaging protrusions 72 of the door 12 are located so as to cross the transfer pathways of the opening pins 65 along the guide slits 70. When the insertion slot 10 is completely closed by the door 12, the opening pins 65 are in front of the engaging protrusions 72 (see FIG. 12).

In tandem with the above-described operation of the door opening mechanism 49, the cartridge carrier 2 linked with the slider 17 via the link mechanism 22 is also moved to the loading position with the above-described movement of the slider 17. Specifically, by the engagement of the hook members 24 of the slider 17 and the first cam carriers 30, the driving force of the slider 17 is transmitted to the cartridge carrier 2 via the link mechanism 22. That is, when the slider 17 is moved toward the loading position, the link mechanism 22 that is engaged with the hook members 24 using the engaging protrusions 31 is driven. The first and second cam carriers 30 and 32 that are linked by the link member 34 thereby rotate, as shown in FIGS. 4 to 6, around the fulcrum pins 35 clockwise in the figure, and move the cartridge carrier 2 that is coupled to the cam carriers 30 and 32 using the engaging pins 40 toward the loading position. At this time, the engaging pins 27 of the hook members 24 move along the straight slit portions 29a of the guide slits 29 of the frame member 6, and the engaging pins 40 of the cartridge carrier 2 move along the straight slit portions 42a of the guide slits 42 of the carrier guides 4a and 4b.

During such movement of the cartridge carrier 2, after the door 12 is completely closed as described above, the shutter 83 of the cartridge C is opened by the shutter opening mechanism 90 at a predetermined time. Specifically, when the depression 83a of the shutter 83 of the cartridge C is engaged with the engaging protrusion 96 of the shutter opening member 92 of the cartridge carrier 2 as shown in FIG. 1, the cartridge carrier 2 is moved toward the loading position as described above. The engaging pin 95 of the shutter opening member 92 thereby moves along the straight portion 97a of the guide groove 97 formed in the sled 4 (see FIG. 2). The cartridge carrier 2 is further moved. As described above, at a predetermined time after the door 12 is closed, the engaging pin 95 of the shutter opening member 92 comes into contact with the working surface 100 of the guide groove 97. Force in the rotational direction thereby acts on the shutter opening member 92. Therefore, the shutter opening member 92 is rotated around the fulcrum pin 99 clockwise in the figure. The engaging pin 95 is moved along the rotation guide portion 97b of the guide groove 97. The engaging protrusion 96 of the shutter opening member 92 moves inward along the guide groove 102 of the cartridge carrier 2. The shutter 83 of the cartridge C that is engaged with the engaging protrusion 96 is opened (the state of FIG. 3).

In this way, the shutter 83 is opened. Next, at a predetermined time, the engaging pins 40 of the cartridge carrier 2 reach the front ends of the straight slit portions 42a of the guide slits 42 and are drop-in caught in the catching slit portions 42b, and the engaging pins 27 of the hook members 24 of the slider 17 also reach the front ends of the straight slit portions 29a of the guide slits 29 and are drop-in caught in the catching slit portions 29b (see FIG. 6). The cartridge carrier 2 is thereby positioned at the loading position slightly lower than the unloading position, and secures an appropriate position relative to the turntable 107 (a position where the cartridge carrier 2 faces the turntable 107 at a distance at which the cartridge carrier 2 can obtain a predetermined holding force and torque from the turntable 107). The hook members 24 rotate downward relative to the slider 17 around the fulcrum pins 25, and are disengaged from the first cam carriers 30. (Therefore, in this disengaged state, as described below, the cartridge carrier 2 can move toward the optical region together with the sled 4 without being constrained by the slider 17.) At this loading position, as shown in FIG. 12, the front ends of the first slit portions 65a of the control slits 65 of the slider 17 are in contact with the engaging pins 63 of the door arms 62.

This loading position is detected by two sensors 180 and 182 shown in FIG. 7. Specifically, for example, during the movement of the slider 17 in the loading direction, the front (first) sensor 180 is temporarily turned on by a predetermined portion of the slider 17, and the loading operation of the slider 17 is detected. Thereafter, after the first sensor 180 is turned off, when the cartridge carrier 2 has reached the loading position, the rear (second) sensor 182 is turned on by a predetermined portion of the slider 17. That is, the first sensor 180 is turned on and is then turned off, and the second sensor 182 is turned on with the first sensor maintained in the off state. It is thereby detected that the cartridge carrier 2 has reached the loading position.

In this way, the loading position of the cartridge carrier 2 is detected by the sensors 180 and 182. The hologram recording medium in the cartridge C is held, for example, magnetically by the turntable 107 opposite the hologram recording medium, and is positioned and fixed relative to the sled 4. In this state, the motor 140 is driven and the lead screw 122 is rotated. The sled 4 that supports the cartridge carrier 2 at the loading position is thereby moved to the optical region where information is written onto the hologram recording medium or information is read from the hologram recording medium. Thereafter, when the cartridge carrier 2 has reached a predetermined writing or reading position in the optical region, the hologram recording medium is rotated by the turntable 107, the sled 4 is moved in the direction of the axis of the lead screw 122, and the cartridge C is moved relative to an immovably-installed optical pickup (including a light source, a light detector, and an optical system). A reading process or writing process is thereby performed on the hologram recording medium in the cartridge C exposed by the opening of the shutter 83, along its radial direction.

This movement in the radial direction of the hologram recording medium in a reading process or writing process is performed without rattling due to the above-described rattle preventing mechanism using urging force of the spring. Therefore, the reading process or writing process can be performed with high accuracy.

In this embodiment, the moving speed of the sled 4 (therefore the moving speed of the cartridge C) is controlled by a control unit (not shown) via the motor 140. Specifically, a moving speed V1 and a moving speed V2 are individually set. The moving speed V1 is the speed at which the cartridge C is moved from the loading position to a predetermined writing position or reading position in the optical region. The moving speed V2 is the speed of the cartridge C during the reading process or writing process. The moving speed of the cartridge C during the movement to the writing position or reading position after loading differs from the moving speed of the cartridge C during the reading process and writing process. In particular, in this embodiment, the moving speed V1 is set higher than the moving speed V2.

After the reading process or writing process is completed, the cartridge C is unloaded through the insertion slot 10 through the reverse operation to the above-described operation. At this time, in conjunction with the unloading operation of the cartridge C (cartridge carrier 2), the door 12 is opened by the above-described door opening mechanism 49. That is, when the slider 17 is moved toward the insertion slot 10 from the state of FIG. 12, as shown in FIG. 11, the first working faces 80 of the control slits 65 of the slider 17 come into contact with the engaging pins 63 of the door arms 62 and rotate the door arms 62 around the fulcrum pins 60 clockwise in the figure. Therefore, as shown in FIG. 11, the opening pins 65 of the door arms 62 located in front of the engaging protrusions 72 of the door 12 as described above move along the guide slits 70, press up the engaging protrusions 72 that cross the transfer pathways of the opening pins 65, and open the door 12. Thereafter, with the movement of the slider 17, the engaging protrusions 72 pressed up by the opening pins 65 are retracted from the transfer pathways of the opening pins 65. The opening pins 65 get over the engaging protrusions 72 and become located behind them. Immediately before that, the open state of the door 12 becomes maintained not by the door arms 62 but by the cartridge C being unloaded. Finally, after the cartridge C is discharged from the insertion slot 10, the door 12 is closed by the urging force of the urging spring 75. In this closed stage, as shown in FIG. 8, the opening pins 65 are located behind the engaging protrusions 72 of the door 12.

As described above, in the recording medium loading and unloading apparatus 1 of this embodiment, only when the insertion slot 10 is closed by the door 12, that is, when the inside of the housing is completely shielded from light, the shutter 83 of the cartridge C is opened and part of the recording medium is exposed from the case. Therefore, light can be prevented from falling on the recording medium at times other than reading and writing of information from and onto the recording medium.

Since the recording medium loading and unloading apparatus 1 of this embodiment is provided with the door opening mechanism 49 that opens the door 12 in conjunction with the loading mechanism, the unloading operation of the cartridge C is not interfered with by the door 12, and the cartridge C can be smoothly unloaded.

In the recording medium loading and unloading apparatus 1 of this embodiment, the shutter opening mechanism 90 includes the shutter opening member 92 that engages with the shutter 83, is rotated in conjunction with the loading mechanism, and thereby opens the shutter 83, and the guide groove (cam groove) 97 that engages with the shutter opening member 92 and defines the timing of opening of the shutter 83 by the shutter opening member 92 so that the shutter opening member 92 can be rotated with the door 12 closed. Therefore, the shutter 83 can be opened with simple structure and movement, and the apparatus can be reduced in size. In addition, since the opening timing is controlled by the cam groove, the shutter 83 can be opened reliably and effectively in conjunction with the closing operation of the door 12.

The recording medium loading and unloading apparatus 1 of this embodiment is provided with the driving source 20A that generates torque for moving the slider 17, and the force converting mechanism 30B that converts the torque generated in this driving source 20A into force in a straight direction and transmits the force to the slider 17. Therefore, a long stroke of the slider 17 can be secured without increasing the driving source in size, the structure can be simplified, and the apparatus can be reduced in size.

### BRIEF DESCRIPTION OF THE DRAWINGS

FIG. 1 is a schematic plan view of a recording medium loading and unloading apparatus according to an embodiment of the present invention, and it shows a state in which a cartridge is inserted.

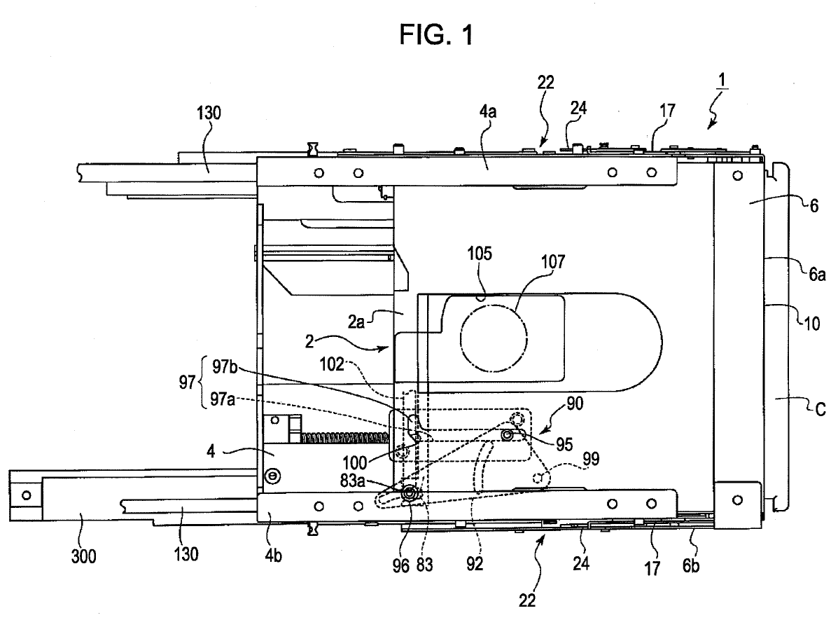

FIG. 2 is a schematic plan view of the recording medium loading and unloading apparatus according to the embodiment of the present invention, and it shows a state in which the cartridge is being moved to the loading position.

FIG. 3 is a schematic plan view of the recording medium loading and unloading apparatus according to the embodiment of the present invention, and it shows a state in which the cartridge is being moved to the loading position and the shutter of the cartridge is open.

FIG. 4 is a side view mainly shows a slider and a link mechanism that move a cartridge carrier of the recording medium loading and unloading apparatus of FIG. 1 in the loading direction, and it shows a state in which the cartridge carrier is disposed at the unloading position.

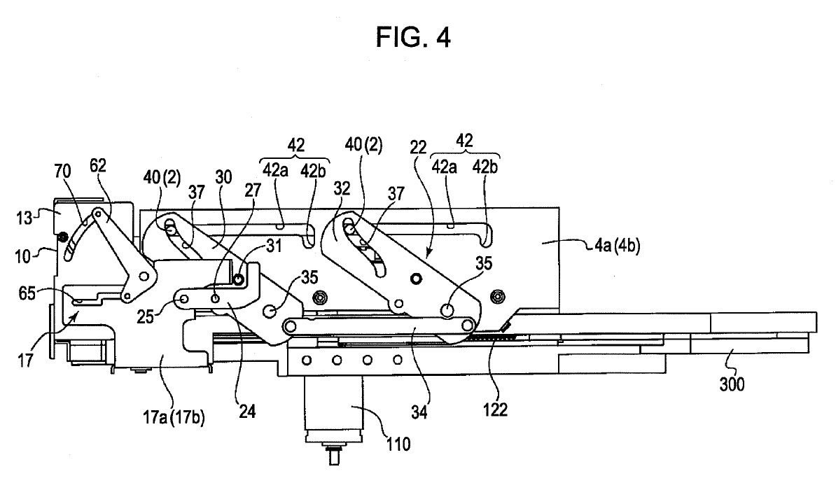

FIG. 5 is a side view mainly shows the slider and the link mechanism that move the cartridge carrier of the recording medium loading and unloading apparatus of FIG. 1 in the loading direction, and it shows a state in which the cartridge carrier is being moved to the loading position.

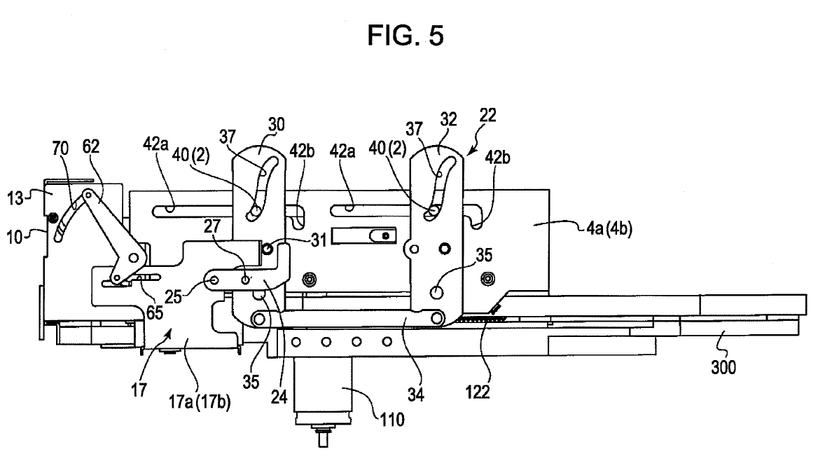

FIG. 6 is a side view mainly shows the slider and the link mechanism that move the cartridge carrier of the recording medium loading and unloading apparatus of FIG. 1 in the loading direction, and it shows a state in which the cartridge carrier is disposed at the loading position.

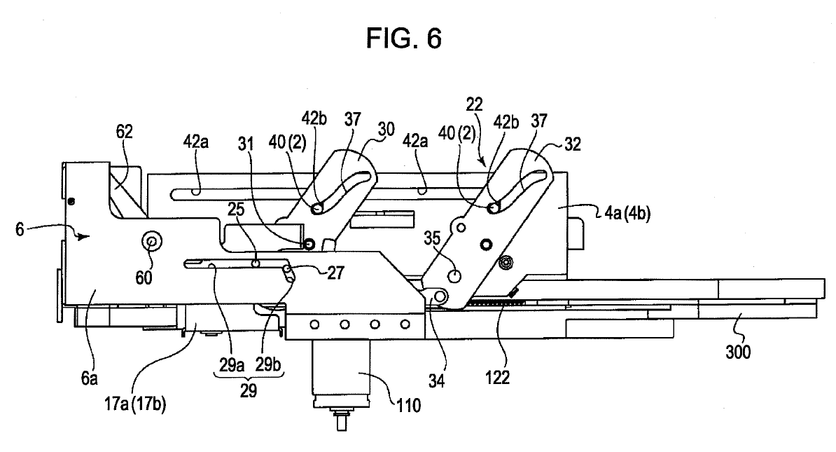

FIG. 7 (a) is a schematic plan view showing the structure of a driving mechanism for driving the slider of the recording medium loading and unloading apparatus of FIG. 1. FIG. 7 (b) is a back view of the structure of FIG. 7 (a).

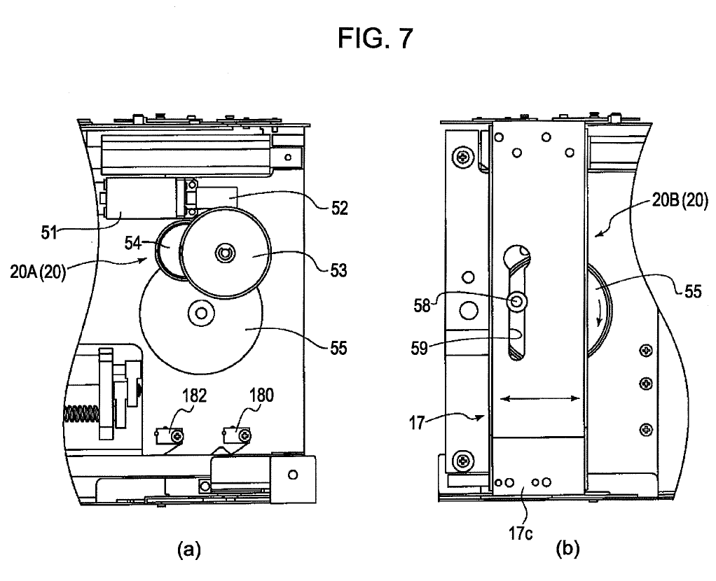

FIG. 8 is a side view mainly showing a door opening mechanism of the recording medium loading and unloading apparatus of FIG. 1, and it shows a state in which the cartridge carrier is disposed at the unloading position and a door is closed.

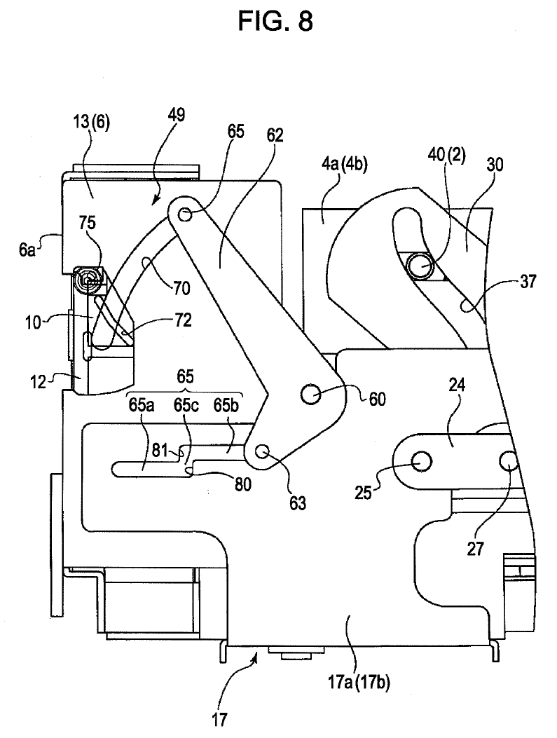

FIG. 9 is a side view mainly showing the door opening mechanism of the recording medium loading and unloading apparatus of FIG. 1, and it shows a state in which the cartridge carrier is disposed at the unloading position, the door is opened by the cartridge, and the cartridge is introduced into the apparatus.

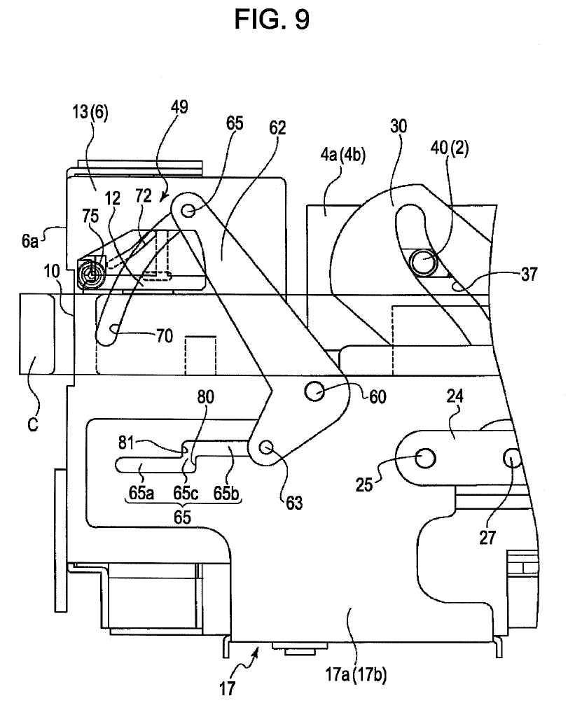

FIG. 10 is a side view mainly showing the door opening mechanism of the recording medium loading and unloading apparatus of FIG. 1, and it shows a state in which the cartridge carrier is being moved to the loading position together with the cartridge.

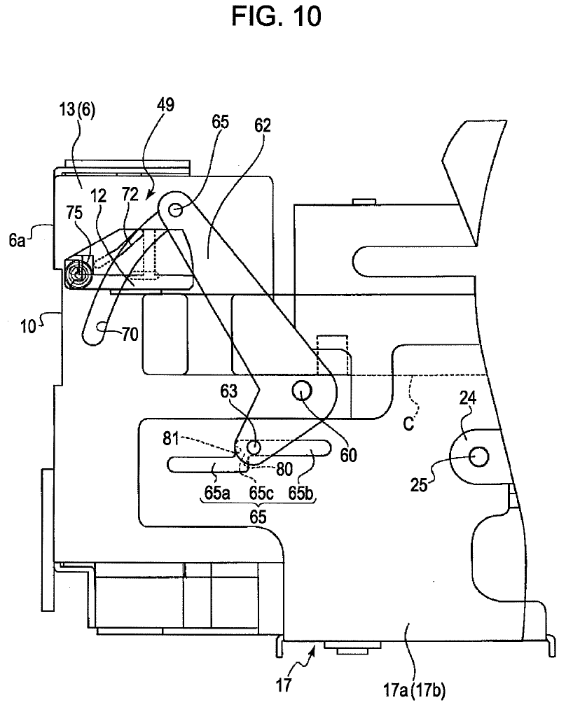

FIG. 11 is a side view mainly showing the door opening mechanism of the recording medium loading and unloading apparatus of FIG. 1, and it shows a state in which the cartridge carrier is being moved to the loading position together with the cartridge, the positional relationship between door arms and the door is changed, and the door is being moved in the closing direction.

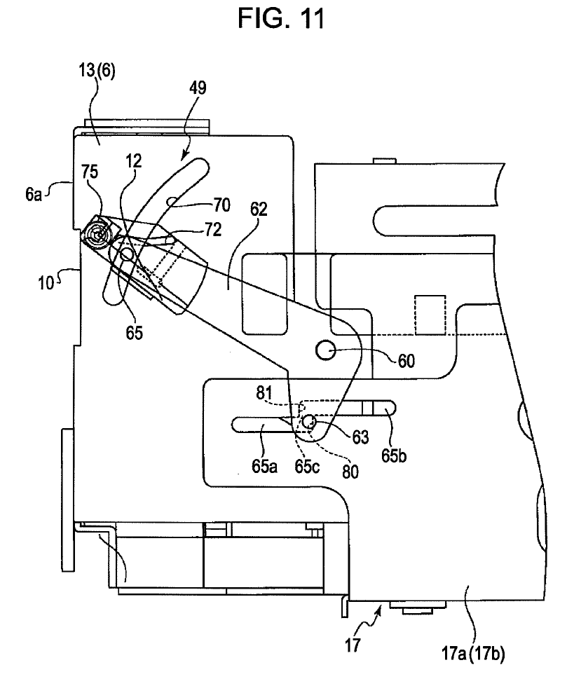

FIG. 12 is a side view mainly showing the door opening mechanism of the recording medium loading and unloading apparatus of FIG. 1, and it shows a state in which the cartridge carrier is disposed at the loading position, and the door is completely closed.

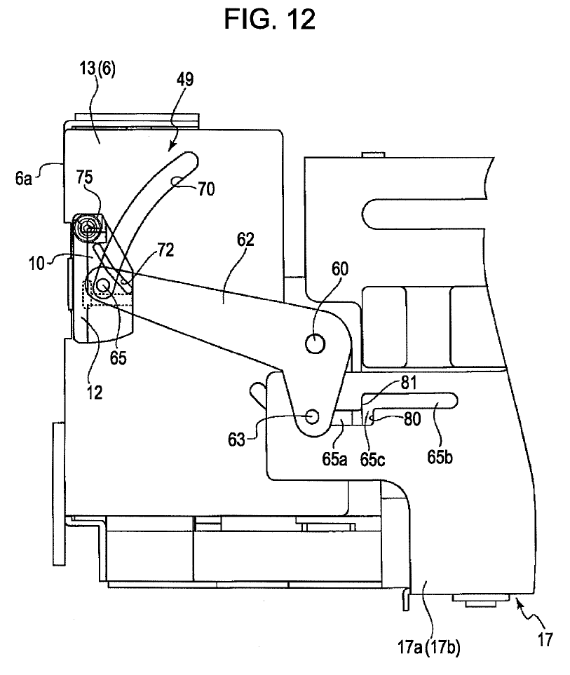

FIG. 13 is a side view mainly showing a moving mechanism that moves a sled of the recording medium loading and unloading apparatus of FIG. 1.

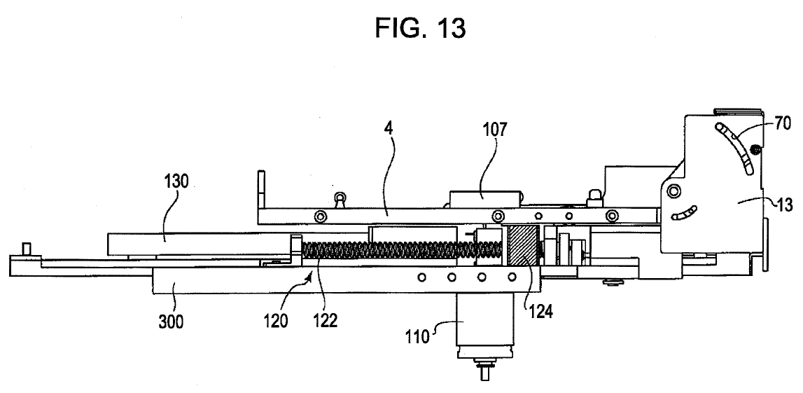

FIG. 14 is a plan view mainly showing the moving mechanism that moves the sled of the recording medium loading and unloading apparatus of FIG. 1.

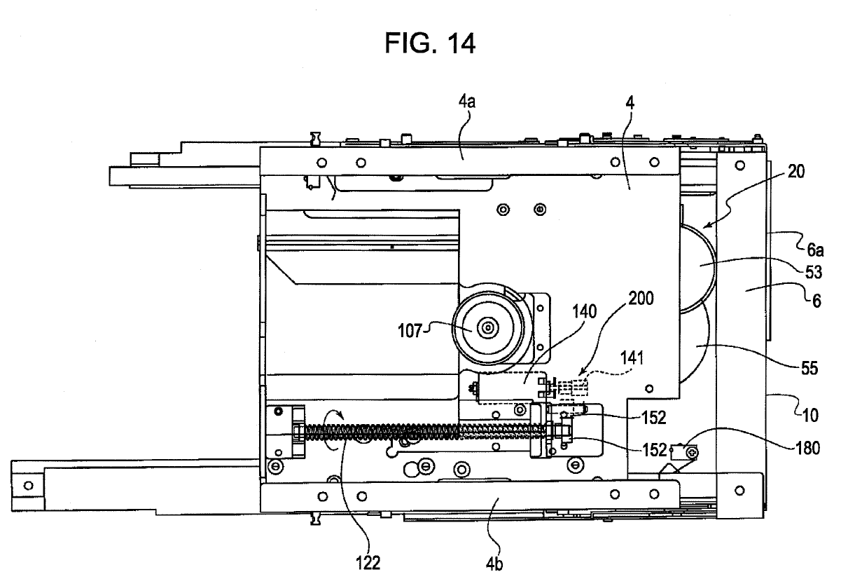

FIG. 15 (a) is a perspective view of a nut assembly that constitutes the moving mechanism of the recording medium loading and unloading apparatus 1 of FIG. 1. FIG. 15 (b) shows the internal structure of the nut assembly of FIG. 15 (a).

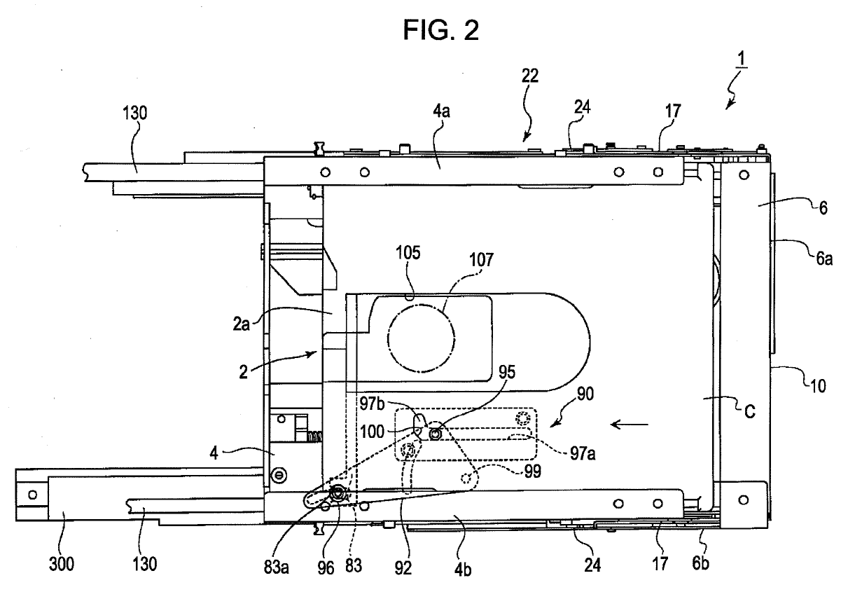

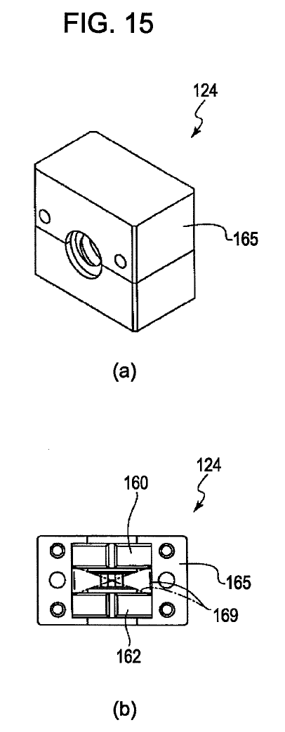

FIG. 2 is a; and

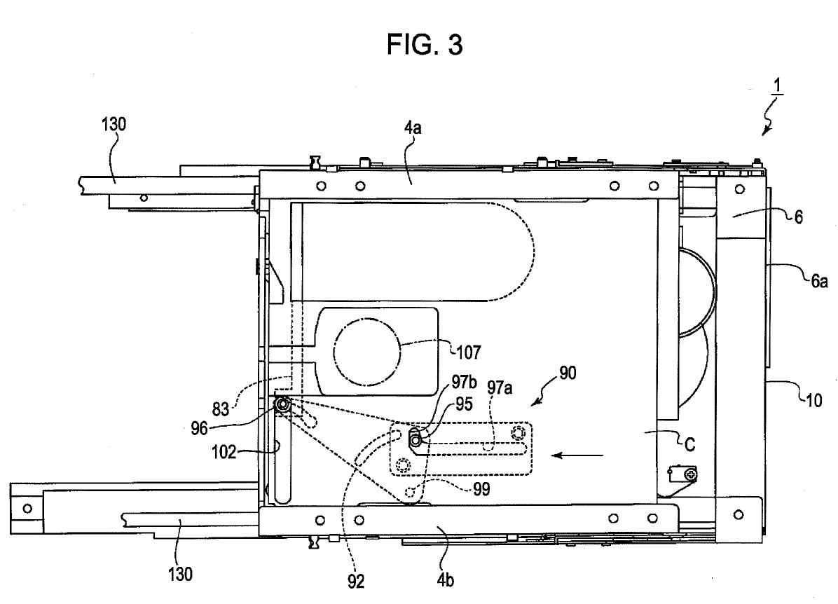

FIG. 3 is a.

### REFERENCE NUMERALS

1 recording medium loading and unloading apparatus
10 insertion slot
12 door
62 door arm (rotating member)
65 opening pin (door engaging portion)
83 shutter
90 shutter opening mechanism 90
92 shutter opening member
96 engaging protrusion (shutter engaging portion)

1. A recording medium loading and unloading apparatus for loading and unloading a recording medium that is housed in a case and forms a cartridge and on which information is optically recorded, the apparatus comprising:
a housing that has an insertion slot into which the cartridge is inserted and that forms a closed space shielded from outside light, in cooperation with a door that openably closes the insertion slot;
a loading mechanism that introduces the cartridge inserted through the insertion slot, into the housing; and
a shutter opening mechanism that is provided in the housing and that opens a shutter provided in the case of the cartridge to expose part of the recording medium from the case during introduction of the cartridge into the housing by the loading mechanism,
wherein the shutter opening mechanism opens the shutter only when the insertion slot is closed by the door.

2. The recording medium loading and unloading apparatus according to claim 1, further comprising a door opening mechanism that opens the door in conjunction with the loading mechanism.

3. The recording medium loading and unloading apparatus according to claim 2, wherein the door opening mechanism includes:
a rotating member that has a door engaging portion engageable with the door and that is rotated in conjunction with the loading mechanism and thereby opens the door using the door engaging portion; and
a door-opening-timing control unit that is provided in the loading mechanism and that engages with the rotating member and rotates this at a predetermined time and thereby controls the timing of opening of the door by the rotating member.

4. The recording medium loading and unloading apparatus according to claim 3, wherein the door-opening-timing control unit is a cam groove that rotates the rotating member to position the door engaging portion at a position engageable with the door when the cartridge is introduced into the housing by the loading mechanism and that rotates the rotating member at a predetermined time to open the door using the door engaging portion when the cartridge is removed from the housing by the loading mechanism.

5. The recording medium loading and unloading apparatus according to any one of claim 1, wherein the shutter opening mechanism includes:
a shutter opening member that has a shutter engaging portion engaging with the shutter and that is rotated in conjunction with the loading mechanism and thereby opens the shutter using the shutter engaging portion; and
a cam groove that engages with the shutter opening member and that defines the timing of opening of the shutter by the shutter opening member so that the shutter opening member is rotated with the door closed.

6. The recording medium loading and unloading apparatus according to any one of claim 1, wherein the loading mechanism includes:
a slider that moves along the insertion direction of the cartridge; and
a carrier that is linked to the slider via a link mechanism and that has a placing surface for placing the cartridge,
wherein the carrier is moved, with the movement of the slider, between an unloading position at which the cartridge is transferred through the insertion slot and a loading position at which the cartridge is positioned in the housing.

7. The recording medium loading and unloading apparatus according to claim 6, further comprising a driving unit that generates torque for moving the slider, and a force converting mechanism that converts the torque generated in the driving unit into force in a straight direction and transmits the force to the slider.
